(19) United States
(12) Patent Application Publication
(10) Pub. No.: US 2025/0139222 A1
(43) Pub. Date: May 1, 2025

(54) METHOD AND SYSTEM FOR OPERATING AN AUTOMATION TECHNOLOGY FIELD DEVICE VIA MACHINE-TO-MACHINE COMMUNICATION BETWEEN AN OPERATING UNIT AND THE FIELD DEVICE

(71) Applicant: Endress+Hauser Conducta GmbH+Co. KG, Gerlingen (DE)

(72) Inventors: Thomas Alber, Stuttgart (DE); Oliver Durm, Benningen am Neckar (DE); Roman Griesser, Gerlingen (DE); Björn Haase, Stuttgart (DE); Martin Lohmann, Gerlingen (DE); Stefan Robl, Hünxe (DE); Karsten Traub, Bietigheim-Bissingen (DE)

(21) Appl. No.: 18/930,879

(22) Filed: Oct. 29, 2024

(30) Foreign Application Priority Data
Oct. 30, 2023 (DE) 10 2023 129 934.4

(51) Int. Cl. G06F 21/44

(52) U.S. Cl. CPC G06F 21/44

(57) ABSTRACT

A method for operating a field device between an operating unit and the field device includes creating an order ticket using a ticket server. The order ticket contains an authorization for the operating unit to carry out defined tasks on the field device and information on the temporal validity. The method also includes transferring the order ticket to an operating unit and to the field device. The operating unit is registered with the field device if the field device verifies the order ticket is valid. If the order ticket is successfully verified, execution of the tasks defined in the order ticket on the field device is authorized for a predetermined period of time, which has an end point that is determined by the information on time validity contained in the order ticket. The authorization is automatically terminated by the field device after the predetermined period of time has elapsed.

### CROSS-REFERENCE TO RELATED APPLICATION

The present application is related to and claims the priority benefit of German Patent Application No. 10 2023 129 934.4, filed on Oct. 30, 2023, the entire contents of which are incorporated herein by reference.

### TECHNICAL FIELD

The present disclosure relates to a method for operating an automation technology field device via machine-to-machine communication between an operating unit and the field device. The present disclosure further relates to a system configured to carry out the method according to the present disclosure.

### BACKGROUND

Field devices that are used in industrial installations are already known from the prior art. Field devices are often used in process automation engineering, as well as in manufacturing automation engineering. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill level measurement etc., and detect the corresponding process variables of pressure, temperature, conductivity, pH value, fill level, flow etc. Actuators are used for influencing process variables. These are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the Endress+Hauser group.

In modern industrial plants, field devices are usually connected to superordinate units via communication networks such as fieldbuses (Profibus®, Foundation® Fieldbus, HART® etc.). Usually, the superordinate units are control systems (DCS) or control units, such as a PLC (programmable logic controller). The superordinate units are used for, among other things, process control, process visualization, and process monitoring, as well as commissioning of the field devices. The measured values recorded by the field devices, such as by sensors, are transmitted via the respective bus system to a (or in some cases a plurality of) superordinate unit(s). In addition, data transmission from the superordinate unit via the bus system to the field devices is also required, such as for configuration and parameterization of field devices and for controlling actuators.

Mobile operating units can also be used to operate field devices that have implemented an FDT frame application. For example, there are operating units that are connected to the fieldbus network. However, the operating unit can also communicate with the field devices via a wireless communications connection, in particular based upon a Bluetooth standard. The applicant produces and sells devices which, as so-called Bluetooth gateways, allow the operating units to be coupled to the field devices. The field device is connected to a Bluetooth gateway via wires, in particular using the HART or CDI communication standards. Alternatively, the field devices themselves have their own Bluetooth interfaces.

If a mobile device, such as a smartphone or tablet, is used as an operating unit for wireless communication with the field devices, application programs, so-called apps, are available which make the operating functions for the field device available to the mobile device.

In industrial environments, most of the installed field devices have no or only very basic protection against unauthorized access. In these field devices, all device parameters can usually be accessed directly or, for example, after entering an unlock code. As a result of the Federal Security Act in Germany, more and more field devices are coming onto the market that have individual user accounts and role-based authorization. For access via a user interface or machine interface, an, in a certain sense “permanent,” authorization is required, which is usually granted by prior authentication. The authorization must be chosen in such a way that the access user has (permanently) all the authorizations they need to carry out their tasks.

In order to reduce the administrative effort for administration of the individual field devices to an acceptable level, there are isolated efforts to centralize administration, as has been common practice in the IT sector for years with regard to IT devices (e.g., printers, workstations, etc.). An example of such a concept is disclosed in DE 10 2018 1026 08 A1, in which a transport means is provided to which user data are transferred from a user database, wherein after checking the user data, access to the field device is granted.

There are also ideas for limiting the access permissions required by people to a minimum. DE 102019131860 A1, for example, discloses providing a digital order ticket which is transmitted from a server to the mobile device, which order ticket contains the access rights and the authorized tasks for the field device. This order ticket is transmitted when the connection is established with the field device. If authorization is available, the tasks contained in the order ticket, such as parameterization actions or execution of functional tests, can be processed with the field device.

The disadvantage of this practice is that persons or machines that need to access the field devices in question have permanent access rights, even if they only access the field devices rarely and for specific tasks. In principle, this also entails a risk of access outside of specific orders which may lead to changes in the configuration or parameterization of the field devices that can not only have a negative impact on the quality of the processes, but may also result in a lack of transparency regarding the status of the individual field devices. Another aspect in this context is that the highest authorizations must be granted in each case, even if such authorizations are rarely needed and in normal cases a role with lower authorization would also be sufficient. This increases the risk of sensitive parameters outside of the current task being changed during normal work on the device.

This is important because current practice still deals very generously with authorizations for machine interfaces. However, since user actions are often tunneled through such connections or users trigger corresponding machine accesses, this entails the same risk of human error as with direct user interfaces.

### SUMMARY

In light of this, the object of the present disclosure is to improve the needs-based allocation of access authorizations to a field device.

As regards the method according to the present disclosure, it is provided for the method to serve for operating an automation technology field device via machine-to-machine communication between an operating unit and the field device and to comprise the following method steps: creating an order ticket using a ticket server, wherein the order ticket contains an authorization for the operating unit to carry out defined tasks on the field device and information on the temporal validity; transferring the order ticket from the ticket server to an operating unit; transmitting the order ticket from the operating unit to the field device; registering the operating unit with the field device if the field device can verify that the order ticket is valid; if the field device can successfully verify the order ticket, execution of the tasks defined in the order ticket on the field device is authorized for a predetermined period of time, which predetermined period has an end point that is determined by the information on time validity contained in the order ticket; and automatically terminating the authorization by the field device after the predetermined period of time has elapsed.

The method according to the present disclosure makes it possible to grant access authorizations to a field device for an operating unit as required and temporarily, wherein only the authorizations required to carry out the current task are granted. In contrast to the concepts known in prior art, the order ticket contains information on validity, whereby a period of time is determined and specified, wherein the authorization is valid only for this period. After the period has ended, the authorization ends so that access to the functions of the field device required to perform the tasks is no longer possible. In general, it is not intended for the order ticket to authorize only certain operating units to carry out the tasks. The order ticket is rather to be used to activate the functionalities for a certain period of time so that operating units can then carry out the tasks regardless of their identity.

In one embodiment of the method, it is provided for the operating unit to register with the field device if the field device can verify that the order ticket is valid, wherein in case of successful registration, the operating unit is authorized for the predetermined period of time, and wherein the operating unit is automatically logged off by the field device after the predetermined period of time has elapsed. Therefore, access authorization for the operating unit is valid only for that period. After the period has ended, the validity ends and the operating unit is logged off. The operating unit is authorized only to carry out exactly these defined tasks. It is not possible to carry out other, different tasks.

A first variant of the method provides for the end point to be a fixed date. The term “date” also includes a time of day. The period is therefore predetermined in such a way that its length is independent of the arrival of the order ticket at the field device. This also makes it possible for the order ticket to arrive at the field device only after the period of time has elapsed. It is then no longer possible to operate the field device for that order ticket.

A first variant of the method provides for the end point to be the completion of the defined tasks on the field device.

A third variant of the method provides for the end point to have a fixed time interval from a starting point, wherein the predetermined time period is defined by the starting point and end point. Specifically, it is provided for the starting point to be the point in time immediately after the order ticket has been positively verified by the field device. The validity information includes a request to the field device to determine the date and/or time of arrival of the order ticket and to calculate the end point based thereon. It may be alternatively provided for the field device to determine the starting point when an event occurs, for example when a new device status occurs (e.g., “maintenance required”).

The operating unit may be a random or a specific operating unit. In the event that the order ticket and the associated tasks are linked to a specific operating unit, a further development of the method provides for authorization to take place only if the operating unit successfully authenticates itself to the field device.

For this purpose, the order ticket can list one or more operating units that are authorized to carry out the operating actions on the field device to complete the task. Authentication means that the operating unit must prove its identity to the field device after the ticket has been transferred. For example, this is done by the operating unit claiming to be the owner of a certain key pair, wherein the public key of the operating unit is transmitted to the field device. Using a challenge response procedure, the operating unit must prove to the field device that it is in possession of the associated private key.

Alternatively, the operating unit sends a signed message with the identification of the operating unit. The field device verifies the signature and trusts that the identity is correct if the signature was successfully verified.

Alternatively, the operating unit sends a message with the identity of the operating unit to the field device, wherein the operating unit encrypts the message. If the message can be decrypted by the field device, the field device trusts the content of the message, i.e., trusts the identity of the operating unit.

In the last two alternatives, trust is based on a signature or encryption, wherein keys are exchanged in advance (“preshared key”).

One embodiment of the method provides for an industrial control unit, in particular a programmable logic controller PLC, to be used as the operating unit, and to be connected to the field device via an industrial network, in particular a fieldbus network. This establishes a so-called “machine-to-machine” communication, i.e., a communication in which no human communication participant is involved (for example via a mobile operating unit such as a smartphone, etc.). This type of order-related access authorization can also be used to ensure that access only occurs at scheduled times or when required in “machine-to-machine” communication. This increases the transparency of changes in the field device configuration, since access can be controlled not only in terms of time, but also with regard to the accessing entity and possibly also with regard to the plausibility or validity when writing data. In addition, unwanted access or changes due to technical errors are virtually eliminated.

An “industrial network” is particularly an automation technology field bus. Such a fieldbus is based (non-exhaustive list), for example, on the protocols HART, Foundation Fieldbus, Profibus PA/DP, Modbus, CAN bus, etc. An “industrial network” can also be Ethernet-based or wireless (e.g., based on the standards WirelessHART, ZigBee, etc.).

Machine-to-machine communication (and the application of the method) can also be established with network components other than a control unit. For example, a gateway or an edge device, or similar can be used. Communication with another field device is also possible.

One advantageous embodiment provides for communication between the control unit and the field device required for the steps of transmitting the order ticket and carrying out the defined tasks on the field device to be carried out in asynchronous or acyclic communication phases of the industrial network. The tasks therefore focus on “special access” to the field device and not on cyclic data communication as is common with Profibus PA/DP, for example. However, a corresponding protocol is required which also allows acyclic access (e.g., Profibus PA/DP, Foundation Fieldbus, etc.).

When using an industrial control unit or another (fieldbus) network participant as an operating unit, it is provided for checking of parameterization data of the field device by the operating unit to be provided as a defined task.

Alternatively or additionally, when using an industrial control unit or another (fieldbus) network participant as an operating unit, it is provided for parameterization of the field device to be provided as an (additionally) defined task, wherein the order ticket includes at least one permitted value range for parameter changes.

Alternatively or additionally, when using an industrial control unit or another (fieldbus) network participant as an operating unit, it is provided for reading logbooks of the field device by the operating unit to be provided as an (additionally) defined task.

One embodiment of the method provides for a time server to be used as an operating unit, wherein synchronizing the system time of the field device with the system time of the time server is provided as a defined task.

According to a development of the method, it is provided for the order ticket to contain cryptographic data, wherein the cryptographic data is used to establish a secure communication connection after the operating unit has registered with the field device. The operating unit has its own fixed key pair. Usually, however, these keys are not used directly, but only indirectly. This means that keys are calculated using a key derivation function (scrypt, PBKDF2, . . . ), which is then actually used. Random numbers (NONCE) are usually used for this derivation. In this case, a secret could be used instead. Both communication partners then calculate the derived key independently of each other and use it to encrypt their messages henceforth. If both have come to the same conclusion, they can decrypt each other's messages.

The order ticket can also be cryptographically signed by the ticket server. The tamper-proof tickets then used can also be transported via insecure connections as proof of authorization.

One embodiment of the method provides for the order ticket to be transmitted from the ticket server to the operating unit via a network connection. The network connection is (in case the ticket server is located remotely) the Internet. If the ticket server is located within the facility or close to the facility, it is an (Ethernet-based) IT network.

As regards the system according to the present disclosure, it is provided for the system to be provided for carrying out the method according to the present disclosure and to comprise an automation technology field device, a ticket server and an operating unit.

Field devices that are mentioned in connection with the present disclosure have already been given as examples in the introductory part of the description.

As already described above, the operating unit can be a control unit in terms of a programmable logic controller (PLC), another network component in terms of a gateway, edge devices, or similar, or another field device.

### BRIEF DESCRIPTION OF THE DRAWINGS

The present disclosure is explained in greater detail with reference to the following figures. In the figures:

FIG. 1 shows an exemplary embodiment of the system according to the present disclosure; and

FIG. 2 shows an exemplary embodiment of the method according to the present disclosure.

### DETAILED DESCRIPTION

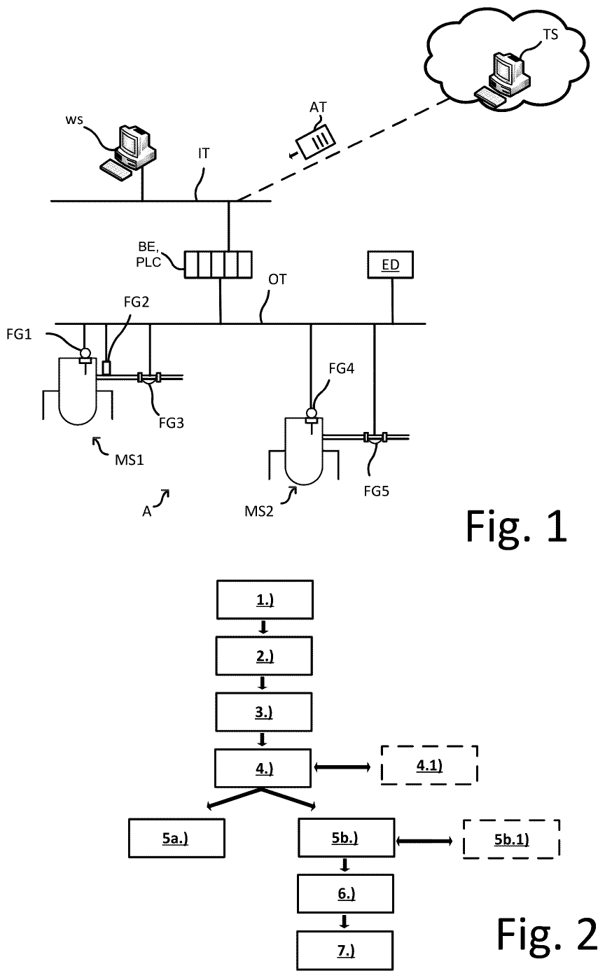

Parts of an automation technology system A are depicted in FIG. 1. Specifically, these are two measuring points MS1, MS2, each of which has several field devices FG1, FG2, FG3, FG4, FG5. These measuring points respectively consist of a tank and a pipeline which discharges from the tank. To measure the fill level of the tank as a process variable, the field devices FG1, FG4, for example with a radar as a sensor unit, are attached to the tank. In order to measure the flow rate in the pipeline, the field devices FG3, FG5 are attached, the respective sensor unit of which determines the flow rate of a medium flowing through the pipeline as the primary process variable according to the Coriolis principle. Furthermore, a field device FG2 is attached at the measuring point MS1, which device determines the temperature of the measured medium flowing through the pipeline by means of a high-precision temperature sensor as a sensor unit.

The field devices FG1, . . . , FG5 are interconnected by means of an industrial network OT (OT=operational technology) and are in communication with one another. The industrial network OT is, in particular, a fieldbus according to one of the known fieldbus standards, e.g., Profibus, Foundation Fieldbus, or HART. Alternatively, the industrial network OT is an Ethernet network.

The industrial network OT includes a superordinate unit PLC, e.g., a programmable logic controller, which transfers commands to the field devices FG1, . . . , FG5, whereupon the field devices FG1, . . . , FG5 transfer process values, diagnostic data, and status information to the superordinate unit PLC. These process values, diagnostic data and status information are forwarded by the superordinate unit PLC to a workstation PC WS in the control station of the system A via an IT network IT. The workstation PC is used, among other things, for process visualization, process monitoring and engineering as well as for operating and monitoring the field devices FG1, . . . , FG5, or it can act as a planning tool (“Enterprise Resource Planning” (ERP), “Enterprise Management System” (EMS), etc.).

Furthermore, the industrial network OT is assigned an edge device ED, which monitors the process values, diagnostic data and status information transmitted by the field devices FG1, . . . , FG5 contained in the respective measuring point MS1, MS2 to the superordinate unit PLC and, if necessary, queries further data from the field devices FG1, . . . , FG5.

The edge device ED can establish a communication connection to a service platform via the Internet, which service platform SP is configured to execute applications. For example, one such application is a plant asset management system that is used to manage the field devices FG1, . . . , FG5.

In the following, the control unit PLC is supposed to operate the field device FG3. Operating means changing parameter values of the current operating parameter set of the field device FG3. The control unit PLC is supposed to have only limited access with regard to the operating time and scope of operation, or the access is part of a higher-level plan and, from the PLC's point of view, represents a temporary event in terms of a work order.

In this context, FIG. 2 shows a process flow of one embodiment of the method according to the present disclosure with method steps 1) to 7). The core of the method according to the present disclosure is based on the fact that special accesses to field devices, in particular those including write accesses, such as the operation of the field device FG3 via the control unit PLC via the industrial network OT in the present case, should not be permanently possible.

For this purpose, in a first method step 1), an order ticket AT is created centrally by a ticket server TS as part of a global task planning. The ticket server TS is a server that can be reached via the Internet. However, the ticket server can also be located close to the system and could, for example, be formed by the workstation PC WS of the system A control system. An order ticket AT is a digital, tamper-proof data packet which, in addition to a signature of the ticket server TS, includes an authorization for the operating unit BE to carry out defined tasks on the field device FG1, FG2, . . . , FG5 and information on temporal validity. In addition to the authorization for this task, the order ticket also contains, for example, a valid value range for the parameters to be written.

In a method step 2), the order ticket AT is transferred from the ticket server TS to the access initiating location, in this case the control unit PLC. Transmission takes place via the Internet to an access point of the communication network IT, which forwards the order ticket AT to the control unit PLC. Alternatively, the control unit PLC in terms of an IIoT device has its own Internet access and is registered with the ticket server TS, so that the latter transmits the order ticket AT directly to the control unit PLC.

In a method step 3), the control unit PLC transmits the order ticket AT to the field device FG3 via the industrial network OT. When using a fieldbus as an industrial network OT, the order ticket AT is transmitted in an acyclic phase of communication. It is further provided for all subsequent communications, or data exchange, between field device FG3 and operating unit BE to take place within the acyclic phase of communication.

In a method step 4), the field device FG3 checks the incoming order ticket AT. In the simplest case, such an order ticket only contains the verifiable authorization to carry out the task by the operating unit BE, i.e., the control unit PLC. To increase security, the order ticket AT contains the requirement that the executing entity, i.e., the control unit PLC, is named and that it must authenticate itself. Authentication of the operating unit BE to the field device FG3 takes place in an optional method step 4.1), which is part of the verification by the field device FG3. The correct identity of the operating unit BE is verified, for example, by the field device FG3 requesting the operating unit BE to authenticate after receiving and checking the ticket. A challenge-response procedure would be suitable in this context. To this end, the field device FG3 sends any (random) phrase and the operating unit BE signs it and sends it back to the field device FG3. The field device FG3 then verifies the signature using a public key. In this case, the public key of the operating unit BE is part of the order ticket.

If the operating unit BE cannot successfully authenticate itself to the field device FG or if verification fails otherwise, the field device FG3 denies access for the operating unit BE in method step 5.a), which terminates the method.

However, if verification has a positive outcome, the field device FG3 allows the operating unit BE access in method step 5b.) and enables the operating unit BE to operate exclusively within the scope of the tasks or operating actions specified in the order ticket AT. In addition, the field device FG specifies a period during which such access is permitted based on the validity information contained in the order ticket AT. A specific date and/or a specific time can be defined in the order ticket AT, which determines the expiration of a period in which operation is permitted. Alternatively, the period of validity is formed by a starting point and an end point. Here, it may be provided for the starting point to be the point in time immediately after the order ticket has been positively verified by the field device FG3. The validity information in the order ticket AT includes a request to the field device FG3 to determine the date and/or time of arrival of the order ticket and to calculate the end point based thereon. It may be alternatively provided for the field device FG3 to determine the starting point when an event occurs, for example when a new device status occurs (e.g., “maintenance required”).

In addition, the field device FG3 limits this order for example to a one-time complete execution. This results in a second (dynamic) criterion for the end of validity. The time by which a task must be completed can also be determined by the higher-level management tool.

Optionally, the field device FG3 and the operating unit BE establish a secure communication connection in method step 5b.1) using cryptographic data contained in the order ticket AT.

The field device FG is then operated within the defined period for the tasks defined in the order ticket in method step 6. In the present case, certain parameter values are changed within the value ranges defined in the order ticket AT.

In a final method step 7), the operating unit BE is logged off the field device FG3; any further operation is no longer possible. Logout takes place automatically. Two options are conceivable for this: automatic logout after successful completion of all tasks defined in the order ticket AT and/or automatic logout after the end of the predetermined period.

Since at least the special access to field devices is possible only with a special order ticket AT, it can only be performed after prior planning. This ensures that the entire parameterization of system A remains unchanged as long as no tasks are planned and carried out. This immensely increases and improves the transparency and controllability of the system status. Furthermore, for example, boundaries in order tickets can be used to limit the result of a task and prevent implausible write accesses or the execution of unwanted parts of the task. Due to the need to prove authorization, sporadic manipulation or attacks are no longer possible.

As an alternative to the control unit PLC, other network components can also serve as an operating unit BE. For example, the edge device ED could operate one of the field devices FG1, . . . , FG5. In that case, the ticket server TS would transmit the order ticket AT to the edge device ED.

In the course of the method, further tasks can also be defined in the order ticket AT. For example, a time server for each component of the industrial network (field devices FG1, . . . , FG5), control unit PLC, edge device ED, etc.) could be given the task once a day of synchronizing it with the system time. Another task could be reading logbooks for a central backup or regularly checking for changes in the parameterization of the field devices FG1, . . . , FG5 by reading hashes.

It may be provided for certain task categories and/or operating units (or a certain combination of tasks and operating units) to not require an order ticket AT (so-called “wildcards”). This is recorded accordingly in the field devices FG1, . . . , FG5. Furthermore, field device groups can be named in the order ticket to reduce the effort required for ticket creation. Also, a 1 out of n relation can be used with regard to the operating unit BE in order to achieve flexibility in technically redundant systems.

1. A method for operating an automation technology field device via machine-to-machine communication between an operating unit and the field device, comprising:
creating an order ticket using a ticket server, wherein the order ticket contains an authorization for the operating unit to carry out defined tasks on the field device and information on the temporal validity;
transferring the order ticket from the ticket server to an operating unit;
transmitting the order ticket from the operating unit to the field device;
registering the operating unit with the field device if the field device can verify that the order ticket is valid;
if the field device can successfully verify the order ticket, execution of the tasks defined in the order ticket on the field device is authorized for a predetermined period of time, which predetermined period has an end point that is determined by the information on time validity contained in the order ticket; and
automatically terminating the authorization by the field device after the predetermined period of time has elapsed.

2. The method according to claim 1, wherein the operating unit registers with the field device if the field device can verify that the order ticket is valid, wherein in case of successful registration, the operating unit is authorized for the predetermined period of time, and wherein the operating unit is automatically logged off by the field device after the predetermined period of time has elapsed.

3. The method according to claim 1, wherein the end point is a fixed date.

4. The method according to claim 1, wherein the end point is the completion of the defined tasks on the field device.

5. The method according to claim 1, wherein the end point has a fixed time interval from a starting point, wherein the predetermined time period is defined by the starting point and end point.

6. The method according to claim 5, wherein the starting point is the point in time immediately after the order ticket has been positively verified by the field device.

7. The method according to claim 1, wherein authorization takes place only if the operating unit successfully authenticates itself to the field device.

8. The method according to claim 1, wherein an industrial control unit, in particular a programmable logic controller, is used as the operating unit, and is connected to the field device via an industrial network, in particular a fieldbus network.

9. The method according to claim 8, wherein communication between the control unit and the field device required for the steps of transmitting the order ticket and carrying out the defined tasks on the field device is carried out in asynchronous or acyclic communication phases of the industrial network.

10. The method according to claim 1, wherein checking of parameterization data of the field device by the operating unit is provided as a defined task.

11. The method according to claim 1, wherein parameterization of the field device is provided as a defined task, and wherein the order ticket includes at least one permitted value range for parameter changes.

12. The method according to claim 1, wherein reading of logbooks of the field device by the operating unit is provided as a defined task.

13. The method according to claim 1, wherein a time server is used as an operating unit, wherein synchronizing the system time of the field device with the system time of the time server is provided as a defined task.

14. The method according to claim 1, wherein the order ticket contains cryptographic data, wherein the cryptographic data is used to establish a secure communication connection after the operating unit has registered with the field device.

15. The method according to claim 1, wherein the order ticket is transmitted from the ticket server to the operating unit via a network connection.

16. A system for operating an automation technology field device via machine-to-machine communication between an operating unit and the field device, comprising:
automation technology field device;
ticket server; and
operating unit;
wherein the system is configured to:
create an order ticket using a ticket server, wherein the order ticket contains an authorization for the operating unit to carry out defined tasks on the field device and information on the temporal validity;
transfer the order ticket from the ticket server to an operating unit;
transmit the order ticket from the operating unit to the field device;
register the operating unit with the field device if the field device can verify that the order ticket is valid;
if the field device can successfully verify the order ticket, execution of the tasks defined in the order ticket on the field device is authorized for a predetermined period of time, which predetermined period has an end point that is determined by the information on time validity contained in the order ticket; and
automatically terminating the authorization by the field device after the predetermined period of time has elapsed.
